(19) United States
(12) Patent Application Publication
(10) Pub. No.: US 2013/0025802 A1
(43) Pub. Date: Jan. 31, 2013

(54) Door structure for temporary shelters

(71) Applicant: Rheal Hamelin, Bromont (CA)

(72) Inventor: Rheal Hamelin, Bromont (CA)

(21) Appl. No.: 13/507,762

(22) Filed: Jul. 26, 2012

(30) Foreign Application Priority Data
Jul. 27, 2011 (CA) 2,747,604

(51) Int. Cl. E06B 9/17

(52) U.S. Cl. 160/269

(57) ABSTRACT

A door structure designed for use with a temporary shelter that has a frame and a material covering the frame with an opening for entry into and exit out of the temporary shelter, the door structure having first and second side members with at least one vertical groove formed therein, a roller extending across an upper portion of the opening, the roller being rotatably journaled at either end, a flexible fabric having one end secured to the roller and a second end having a weight secured thereto, a guide member extending outwardly from the flexible fabric fitting in the vertical groove of the side members, and a device connected to the roller to rotate the same, and clamp members to secure the door structure to the frame of the shelter.

### FIELD OF THE INVENTION

The present invention relates to temporary shelters and more particularly, relates to a door structure for use with such temporary shelters.

### BACKGROUND OF THE INVENTION

Over the years, temporary shelters have become widely accepted and used to protect an object during inclement weather. Such inclement weather includes snow and the like which frequently-occurs in more northerly climates.

Typically, the temporary shelters comprise a metallic frame having a reinforced plastic material covering the frame. Although the temporary shelter may be used to shelter many different objects, the most common use is for sheltering an automobile. Such temporary shelters relieve the owner of the problem of cleaning off the car following snow or ice or the like.

The plastic material covers the top, sides and back wall of the shelter. The front provides access to the interior of the shelter and typically, sliding doors are provided. The doors are again made of a plastic material; they may be slid into position and secured together to prevent the winds blowing snow or the like into the interior of the shelter.

One of the problems encountered with the temporary shelters is that many manufacturers exist. The type of door which will function is dictated by the particular design of the temporary structure. Therefore, it would be a problem to retrofit the temporary shelter with a door structure unless the same is supplied by the manufacturer of the temporary shelter.

### SUMMARY OF THE INVENTION

It is an object of the present invention to provide a door structure suitable for use with temporary shelters.

According to one aspect of the present invention, there is provided a door structure for a temporary shelter which has a frame and a material covering the frame, an opening for entry into and exit out of the temporary shelter, a door structure sitting within the frame and defining the opening, the door structure comprising first and second side members, each of the first and second side members having at least one vertical groove formed therein a roller extending across an upper portion of the opening, the roller being rotatably journaled at either end, a flexible fabric, one end of the flexible fabric being secured to the roller, a second end of the flexible fabric having a weight secured thereto, a guide member extending outwardly from the flexible fabric, the guide member fitting in the vertical groove, a device connected to the roller, the device being designed to rotate the roller, and clamp members to secure the door structure to the frame of the shelter.

According to a further aspect of the present invention, there is also provided a kit for a door structure for a temporary shelter, the kit comprising first and second side members, each the first and second side members having first and second vertical grooves formed therein, a roller extending across an upper portion of the opening, the roller being rotatably journaled at either end, a flexible fabric, one end of the flexible fabric being secured to the roller, a second end of the flexible fabric having a weight secured thereto, a guide member extending outwardly from the flexible fabric, the guide member being designed to fit in one of the vertical grooves, an electric motor arranged to drive the roller, clamp members to secure the door structure to the frame of the shelter, and first and second panels to extend between respective first and second side members and the temporary shelter.

The door structure of the present invention is designed to be compatible with most known temporary shelters. It may conveniently be supplied as a kit for the do-it-yourselfer to install.

The movement of the door about the roller may be accomplished either by manual means or through an electric motor. Generally, the use of the electric motor is preferred since it overcomes the problem with many known temporary shelters of the driver having to exit the car when either entering or leaving the temporary shelter.

The end of the door closest to the ground contains a weight therein along with a guide to fit within the channel of the side member. The inclusion of the weight ensures proper positioning of the end of the door and, in case of manual operation, provides a self closing door.

The door structure may be designed for both single and double vehicle temporary shelters. In the case of a two vehicle temporary shelter, separate controls could be provided for each door.

The motor (when used) for driving the roller and thereby opening and closing the door is preferably battery powered using a charger connected to the electric grid.

As used herein, the term “fabric” means a sheet material which forms the door of the door structure. The sheet material may be any desired including a material similar to that forming the temporary shelter.

The door structure of the present invention uses a plurality of clamps to secure the various components in place. In one preferred embodiment, all the clamps are similar thus simplifying the structure.

### BRIEF DESCRIPTION OF THE DRAWINGS

Having thus generally described the invention, reference will be made to the accompanying drawings illustrating embodiments thereof, in which:

FIG. 1 is a perspective view of a temporary shelter for an automobile with the door in a partially open configuration;

FIG. 2 is a perspective view of a temporary shelter for use with two vehicles;

FIG. 3 is a front view, partially in cutaway, of a temporary shelter and the use of a remote control;

FIG. 4 is a front view of one embodiment of a temporary shelter;

FIG. 5 is a front elevational view of a further embodiment thereof;

FIG. 6 is a front view of a two vehicle temporary shelter;

FIG. 7 is a perspective view of the side portion as seen from inside the shelter;

FIG. 8 is a perspective view illustrating the other side of the mechanism;

FIG. 9 is a detailed view illustrating the motor portion when held in position;

FIG. 10 is a view similar to FIG. 9 illustrating different mounting of the motor;

FIG. 11 is a view illustrating the interior of the motor housing;

FIG. 12 illustrates the fine adjustment of the position of the roller;

FIG. 13 is a perspective view showing the bottom portion of the door structure;

FIG. 14 is a cross-sectional view taken along the lines 14-14 of FIG. 13; and

FIG. 15 illustrates the opening of the door by manual means.

### DETAILED DESCRIPTION OF THE INVENTION

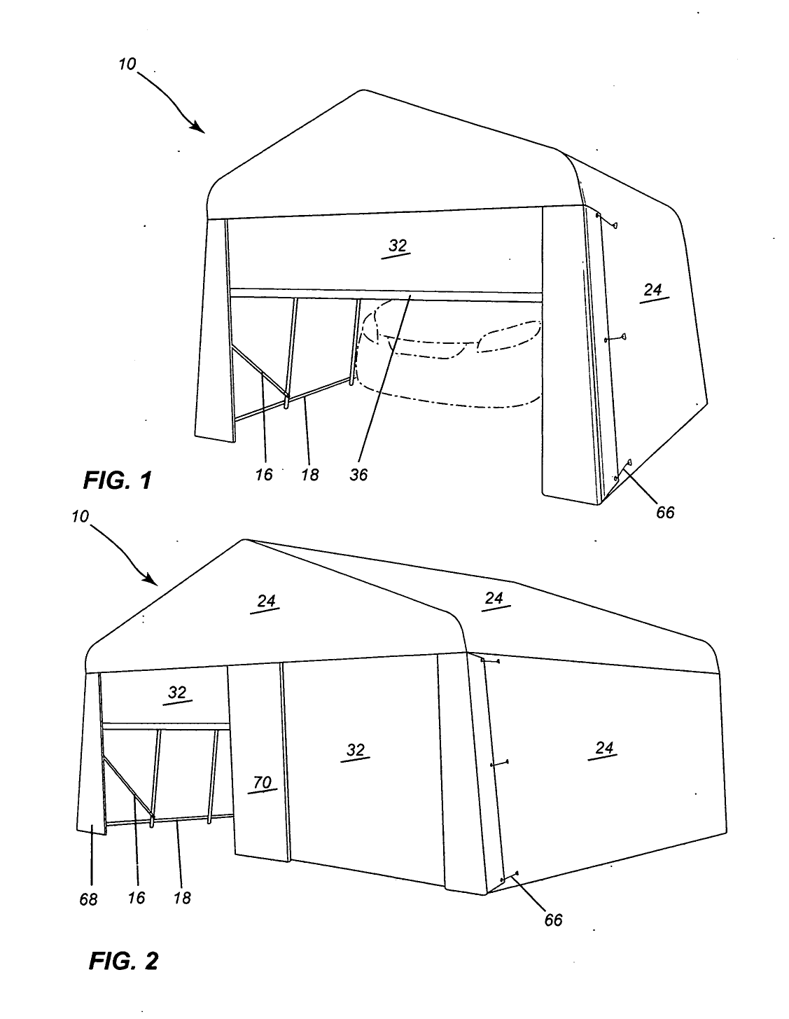

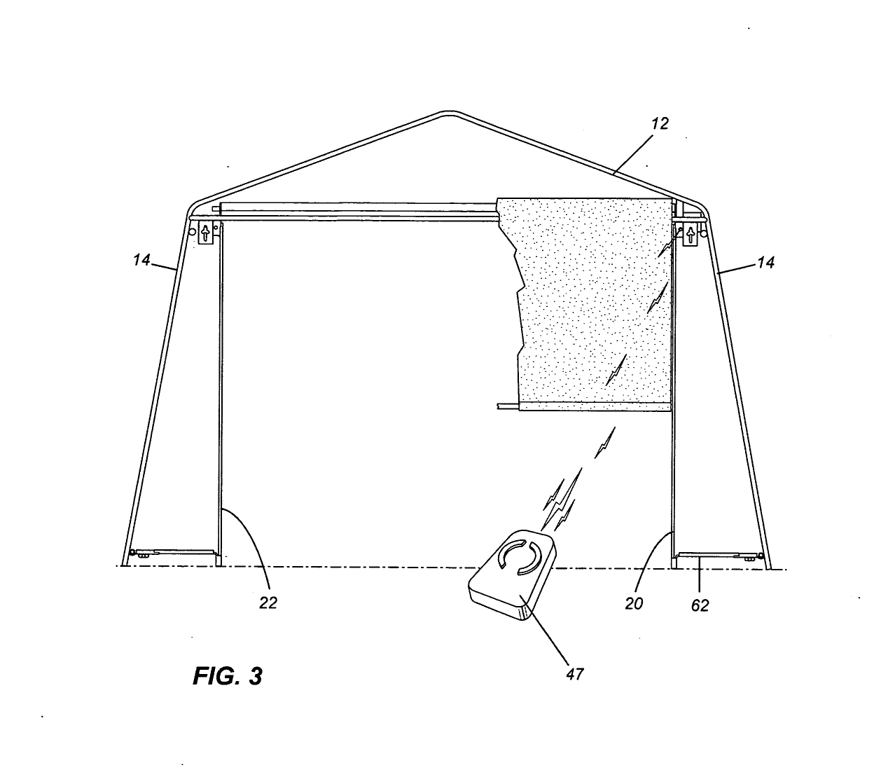

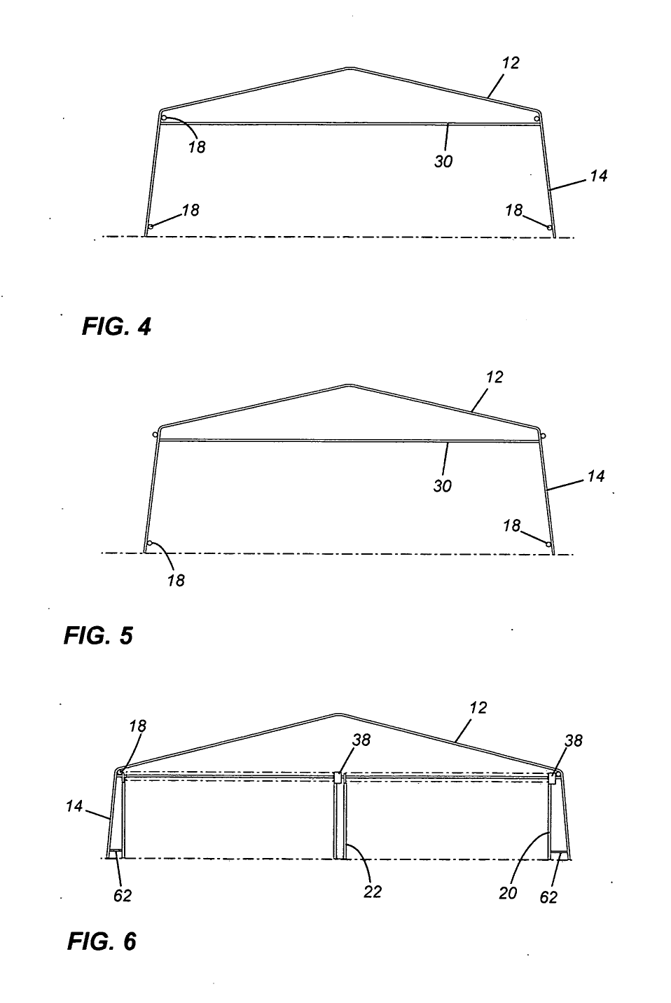

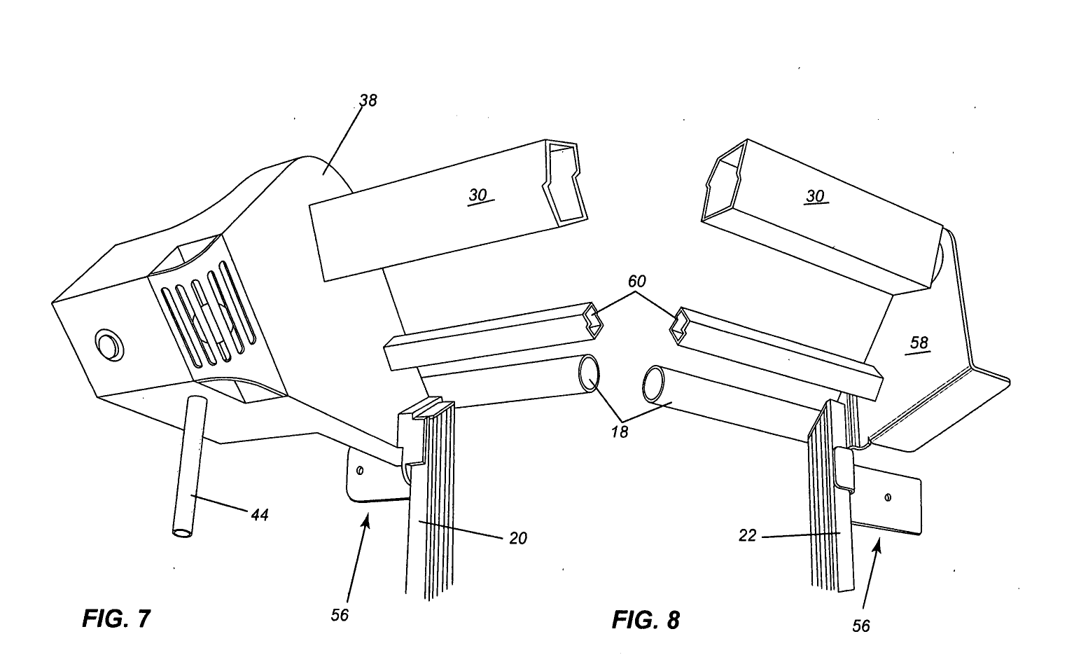

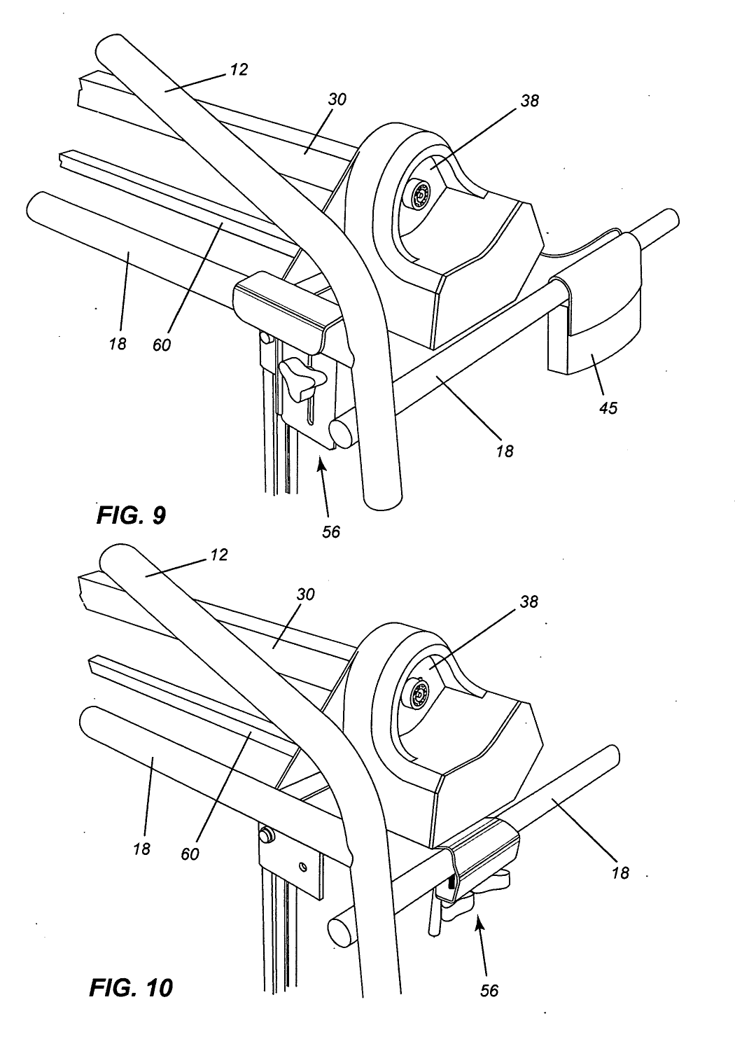

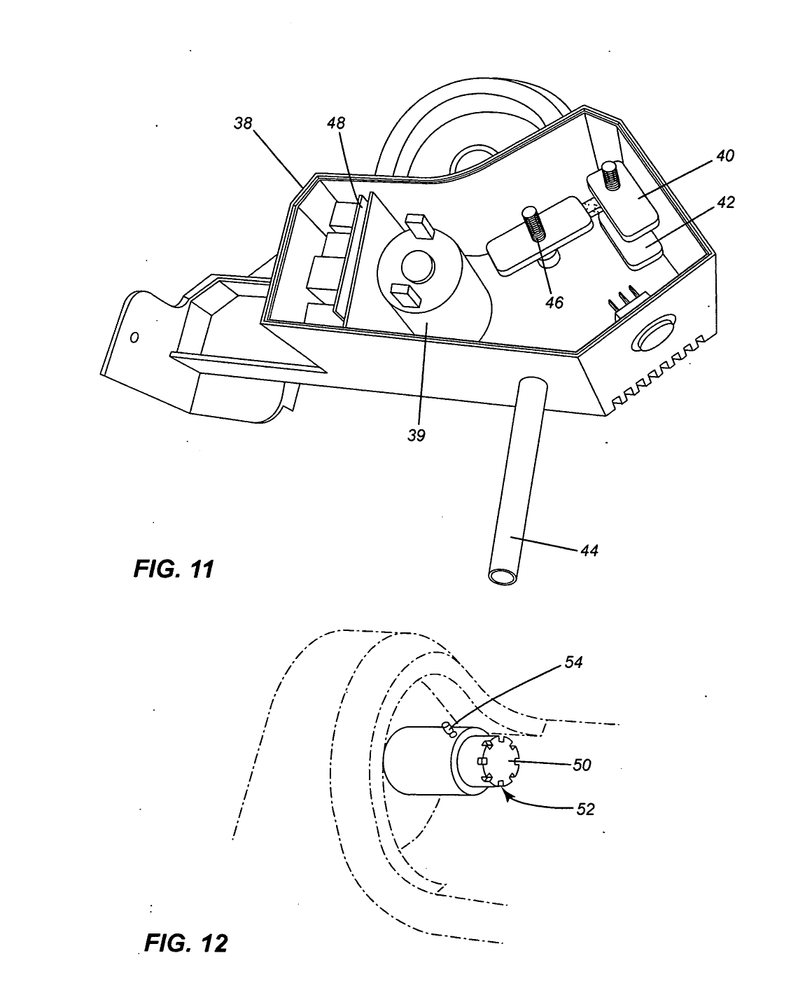

Referring to the drawings in greater detail and by reference characters thereto, there is illustrated in FIG. 1 a temporary shelter generally designated by reference numeral 10. Temporary shelter 10 has a number of different frame members. Thus, as illustrated in the drawings, there is a top frame member 12, a vertical side frame member 14, diagonal side frame members 16 and horizontal side frame members 18. Needless to say, there are a variety of different arrangements of the frame members and the ones illustrated herein are merely representative of such structures as known in the art. A fabric material 24 extends over the various frame members and is generally secured thereto. As previously mentioned, preferably the fabric material 24 may be of a plastic material.

The door structure includes a first vertical side member 20 and second vertical side member 22. As vertical side members 20, 22 are substantially identical, only one will be described herein. Vertical side member 20 extends upwardly and includes a first vertical groove 26 and a second vertical groove 28. Vertical side members 20, 22 are held in position by brackets as will be discussed hereinbelow.

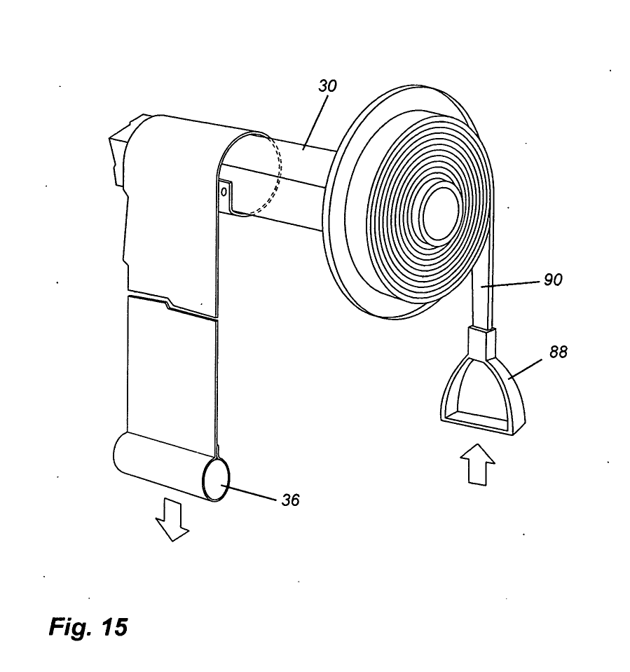

A telescopic roller 30 has mounted thereon a fabric 32 which forms the door. A first end of fabric 32 is secured to roller 30 by any suitable means and the material wound thereabout. Roller 30 is preferably telescopic in order to accommodate differing size openings. A guide member 34 is designed to fit within groove 26 of vertical side member 20 as may be best seen in FIG. 14. At the other end, fabric 32 has a weight 36 secured therein. Weight 36 may conveniently be a plastic tube which is telescopic.

Roller 30 is rotatably driven and to this end, there is provided a motor housing 38. Within motor housing 38 there is a motor 39. There is also provided a start contact 40 and a stop contact 42. A battery 45 is provided to power motor 39. A remote control 47 is provided to control motor 39 for a stop/start operation. To this end, there may be provided an antenna 44. Interiorly of motor housing 38 is a circuit board 48 along with an adjustment screw 46.

In order to provide for an initial adjustment, and as may be seen in FIG. 12, roller 30 has apertures 52 and a pin 54 may be inserted when roller 30 is in the correct position. On the other side of the structure, there is provided a support member 58. A telescopic stabilizer bar 60 extends therebetween.

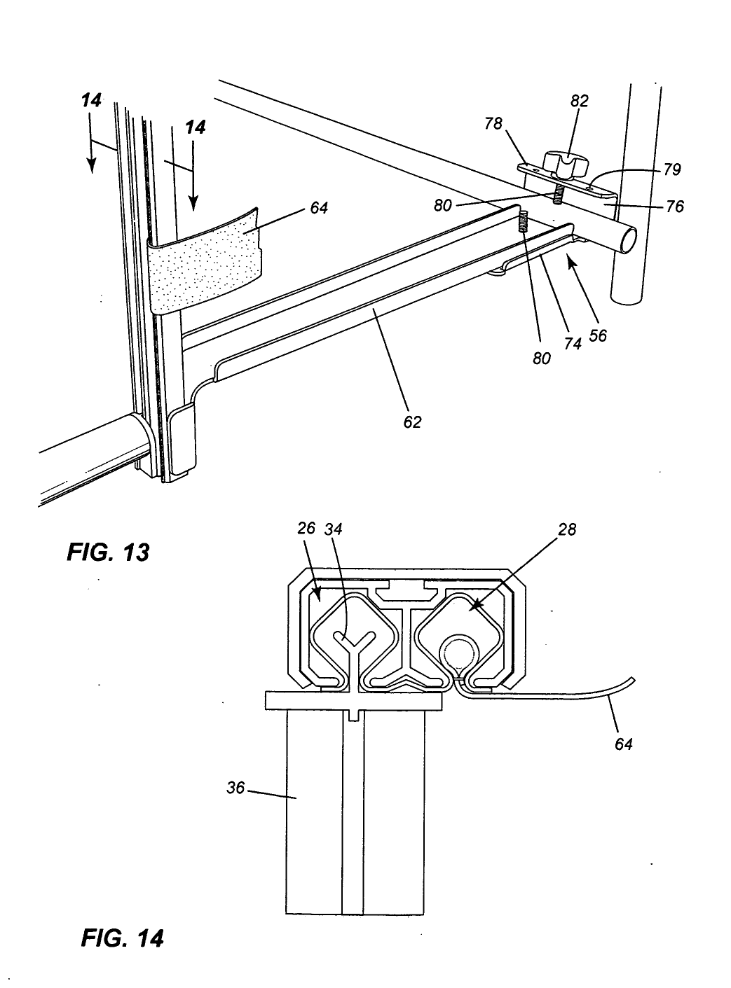

As shown in FIG. 13, a bottom reinforcement bar 62 will extend between vertical side frame member 14 and vertical side member 20. A bracket 56 provides a connection between bottom reinforcement member 62 and horizontal side frame member 18.

A panel 64 extends between second groove 28 and the material 32 forming the temporary shelter. A plurality of bungee cords 66 secure the side panel 64 in place. On the other side, there is a second side panel 68 while in the case of a two car temporary shelter, there may also be provided a center panel 70.

All brackets 56 have an identical configuration and as best shown in FIG. 13, have a first arm 74 and a second arm 76 which are substantially perpendicular to each other. An inwardly extending flange 78 has apertures 79 formed therein. Similar apertures are provided on arm 74. Apertures 79 are screwthreaded and designed to receive a bolt 80 having a head 82. Bolts 80 retain the two arms of the bracket in place.

As shown in FIGS. 9 and 10 brackets 56 may be arranged in various manners. Thus, in FIG. 9, bracket 56 may retain motor housing 38 from a front horizontal bar 18. Alternatively, as shown in FIG. 10, bracket 56 may be secured to a horizontal bar extending the length of the temporary shelter.

As an alternative to the above arrangement, a manual movement of the door may be provided. Thus, the door would be held in a rolled position by a suitable member preventing it from unrolling to close the opening. Once the member is moved, weight 36 will unroll the door through gravity. A handle 88 may be connected to a strap 90 to raise the door when required.

It will be understood that the above described embodiments are for purposes of illustration only and that changes and modifications may be made thereto without departing from the spirit and scope of the invention.

I claim:

1. A door structure for a temporary shelter which has a frame and a material covering said frame, an opening for entry into and exit out of said temporary shelter, a door structure sitting within said frame and defining said opening, said door structure comprising:
first and second side members, each of said first and second side members having at least one vertical groove formed therein;
a roller extending across an upper portion of said opening, said roller being rotatably journaled at either end;
a flexible fabric, one end of said flexible fabric being secured to said roller, a second end of said flexible fabric having a weight secured thereto;
a guide member extending outwardly from said flexible fabric, said guide member fitting in said vertical groove;
a device connected to said roller, said device being designed to rotate said roller; and
clamp members to secure said door structure to said frame of said shelter.

2. The door structure of claim 1 wherein said device connected to said roller to rotate said roller comprises an electric motor.

3. The door structure of claim 2 further including a battery, said battery providing power for said electric motor.

4. The door structure of claim 3 further including a remote control to activate and deactivate said motor.

5. The door structure of claim 1 wherein said device comprises a manually operated member.

6. The door structure of claim 1 further including a stabilizer bar extending horizontally across said temporary shelter.

7. The door structure of claim 1 wherein each of said side members has first and second vertical grooves.

8. The door structure of claim 4 further including an antenna to receive a signal from said remote control.

9. The door structure of claim 2 wherein said roller includes means for adjusting said drive shaft.

10. The door structure of claim 1 wherein a plurality of clamps secure said door structure to said frame, all of said clamps having a substantially identical configuration, said clamps having a threaded member to engage with said frame.

11. The door structure of claim 1 wherein said roller is of a telescopic structure.

12. The door structure of claim 1 further including first and second side panels, said side panels being secured to said first and second side members, a bungee cord interconnecting said side panels with said temporary shelter.

13. A kit for a door structure for a temporary shelter, said kit comprising:
first and second side members, each said first and second side members having first and second vertical grooves formed therein;
a roller extending across an upper portion of said opening, said roller being rotatably journaled at either end;
a flexible fabric, one end of said flexible fabric being secured to said roller, a second end of said flexible fabric having a weight secured thereto;
a guide member extending outwardly from said flexible fabric, said guide member being designed to fit in one of said vertical grooves;
an electric motor arranged to drive said roller;
clamp members to secure said door structure to said frame of said shelter; and
first and second panels to extend between respective first and second side members and said temporary shelter.
